(19) United States
(12) Patent Application Publication
(10) Pub. No.: US 2020/0383521 A1
(43) Pub. Date: Dec. 10, 2020

(54) Heat Sensing Cooking Assembly

(71) Applicant: Michael Mitchell, Shelton, WA (US)

(72) Inventor: Michael Mitchell, Shelton, WA (US)

(21) Appl. No.: 16/433,776

(22) Filed: Jun. 6, 2019

(51) Int. Cl. A47J 36/32; A47J 27/00; H05B 1/02

(52) U.S. Cl. CPC A47J 36/32; H05B 1/0266; A47J 27/004

(57) ABSTRACT

A heat sensing cooking assembly includes a hot plate, a cooking element positioned on the hot plate, a control circuit coupled to the hot plate, a thermometer coupled to the hot plate and an output port coupled to the hot plate. A first thermocouple is removably plugged into the output port. The first thermocouple is draped into a pot to be in thermal communication with a food item that is being cooked in the pot. A second thermocouple is removably plugged into the output port. The second thermocouple engages a port on a lid of a pressure canner that has been placed on the cooking element such that the coupler is in thermal communication with an interior of the pressure canner. A control unit is coupled to the hot plate and the control unit setting a desired temperature for the cooking element.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to cooking devices and more particularly pertains to a new cooking device for controlling the temperature of a pressure canner.

### BRIEF SUMMARY OF THE INVENTION

An embodiment of the disclosure meets the needs presented above by generally comprising a hot plate, a cooking element positioned on the hot plate, a control circuit coupled to the hot plate, a thermometer coupled to the hot plate and an output port coupled to the hot plate. A first thermocouple is removably plugged into the output port. The first thermocouple is draped into a pot to be in thermal communication with a food item that is being cooked in the pot. A second thermocouple is removably plugged into the output port. The second thermocouple engages a port on a lid of a pressure canner that has been placed on the cooking element such that the coupler is in thermal communication with an interior of the pressure canner. A control unit is coupled to the hot plate and the control unit setting a desired temperature for the cooking element.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded top perspective view of a heat sensing cooking assembly according to an embodiment of the disclosure.

FIG. 2 is a front view of an embodiment of the disclosure showing a first thermocouple being draped into a pot.

FIG. 3 is a front view of an embodiment of the disclosure showing a second thermocouple being coupled to a pressure canner.

FIG. 4 is a top view of an embodiment of the disclosure.

FIG. 5 is a schematic view of an embodiment of the disclosure.

### DETAILED DESCRIPTION OF THE INVENTION

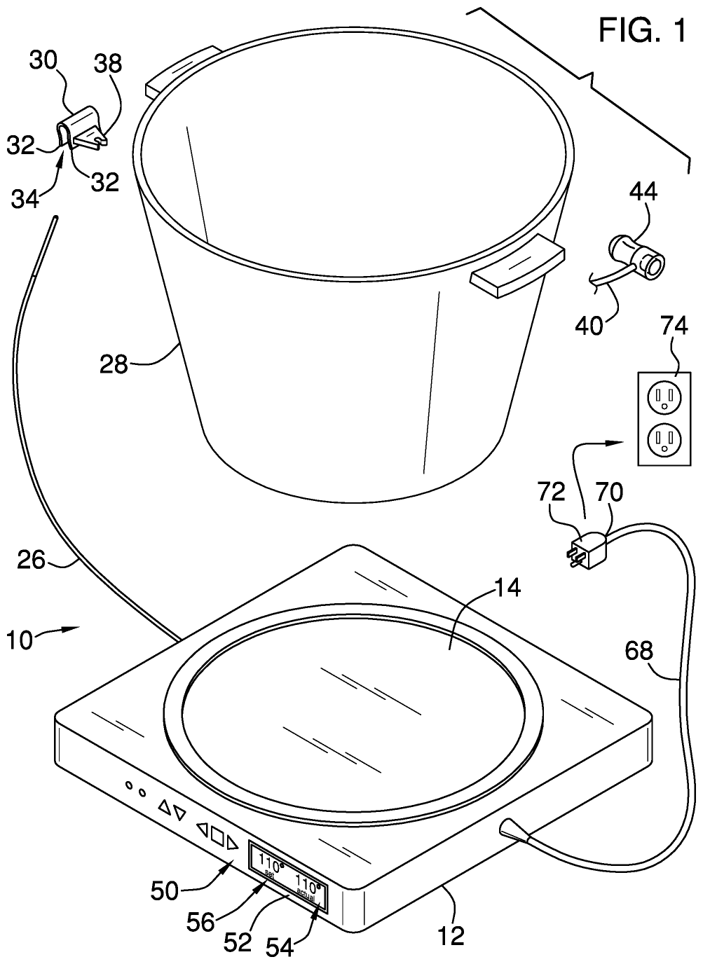

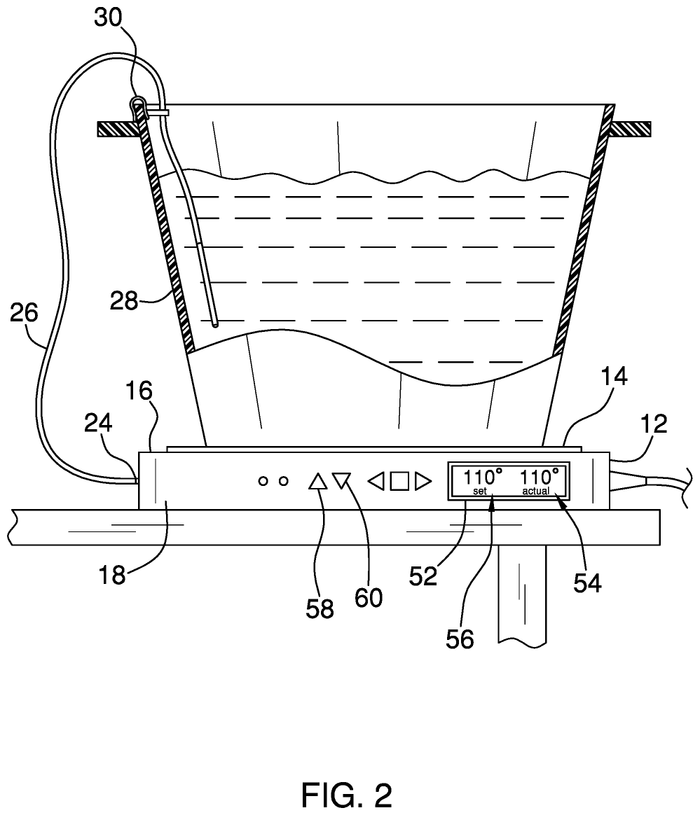

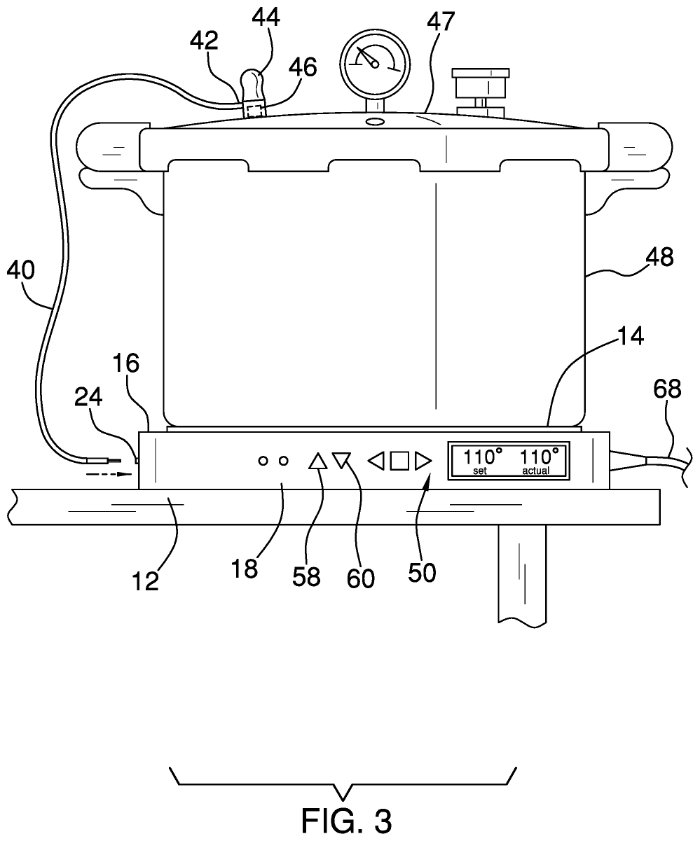

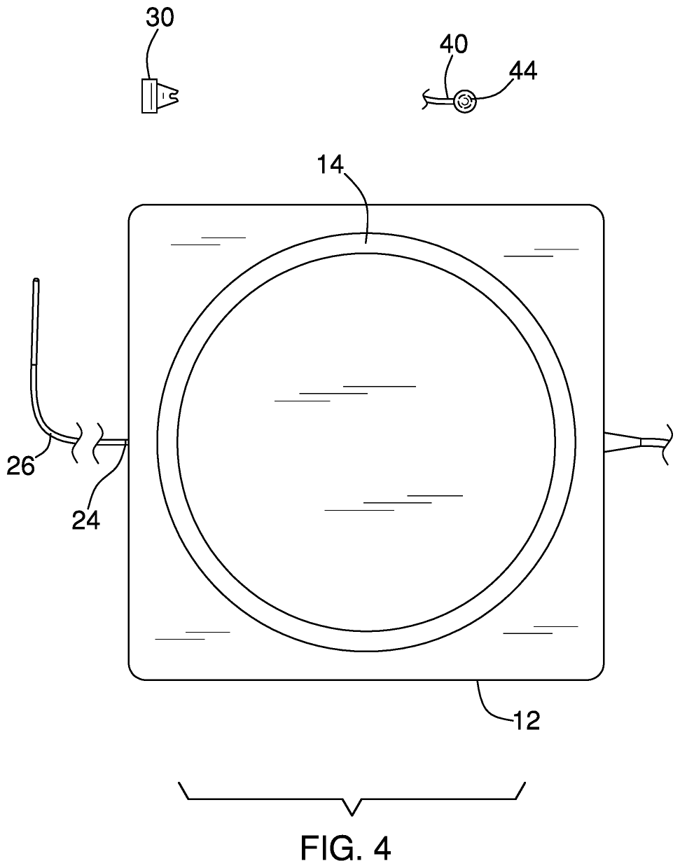

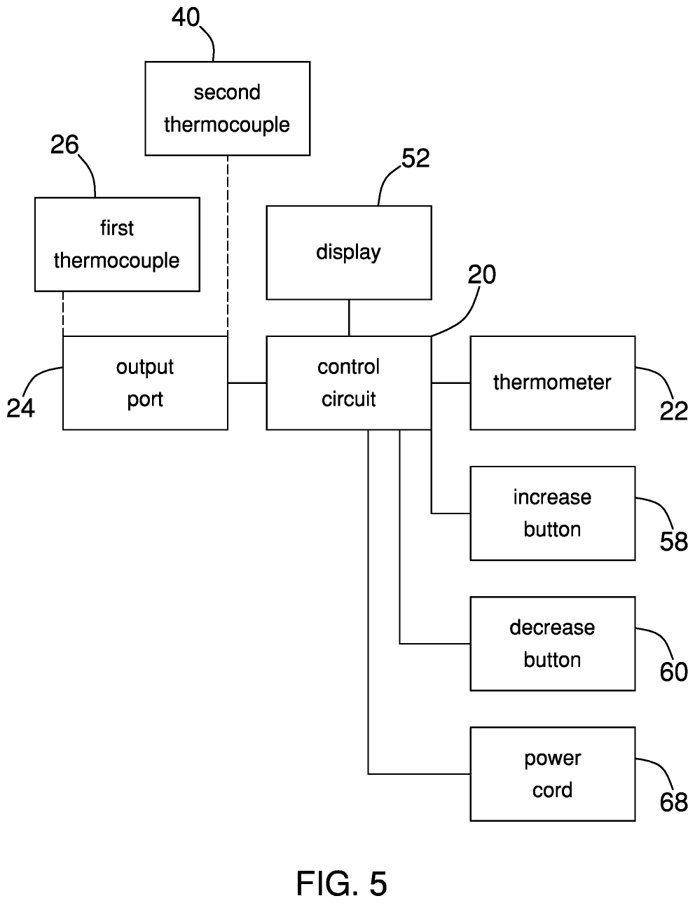

With reference now to the drawings, and in particular to FIGS. 1 through 5 thereof, a new cooking device embodying the principles and concepts of an embodiment of the disclosure and generally designated by the reference numeral 10 will be described.

As best illustrated in FIGS. 1 through 5, the heat sensing cooking assembly 10 generally comprises a hot plate 12 that has a cooking element 14 positioned thereon. The cooking element 14 produces heat when the cooking element 14 is turned on. The hot plate 12 has a top side 16 and a front side 18, and the cooking element 14 is positioned on the top side 16. Additionally, the cooking element 14 may be an electric cooking element that has a circular shape. A control circuit 20 is coupled to the hot plate 12 and the control circuit 20 receives an on input and an off input. The control circuit 20 may include a proportional integral derivative controller or the like. The cooking element 14 is turned off when the control circuit 20 receives the off input and the cooking element 14 is turned on when the control circuit 20 receives the on input.

A thermometer 22 is coupled to the hot plate 12 and the thermometer 22 is electrically coupled to the control circuit 20. The thermometer 22 may be an electronic thermometer or the like. An output port 24 is coupled to the hot plate 12 and the output port 24 is electrically coupled to the control circuit 20. Thus, the output port 24 is in electrical communication with the thermometer 22. The output port 24 may be a female electrical port of any conventional design.

A first thermocouple 26 is removably plugged into the output port 24 such that the first thermocouple 26 is in electrical communication with the thermometer 22. The first thermocouple 26 is draped into a pot 28 that has been placed on the cooking element 14 thereby placing the first thermocouple 26 in thermal communication with an interior of the pot 28. In this way the first thermocouple 26 is in thermal communication with a food item that is being cooked in the pot 28. The first thermocouple 26 may be an electronic thermocouple that includes a male plug, a conductor and a sensor. The male plug may be inserted into the output port 24 and the sensor may be positioned in the pot 28.

A clip 30 is provided that has a pair of members 32 being spaced apart from each other to define a pot space 34 therebetween. The pot space 34 receives a top edge 36 of the pot 28 for retaining the clip 30 on the pot 28. A grip 38 extends laterally away from the clip 30, and the grip 38 releasably engages the conductor of the first thermocouple 26. In this way the first thermocouple 26 is inhibited from falling out of the pot 28.

A second thermocouple 40 is provided and the second thermocouple 40 is removably plugged into the output port 24 such that the second thermocouple 40 is in electrical communication with the thermometer 22. The second thermocouple 40 has a distal end 42 with respect to the output port 24 and the distal end 42 has a coupler 44 thereon. The coupler 44 releasably engages a port 46 on a lid 47 of a pressure canner 48 that has been placed on the cooking element 14. In this way the coupler 44 is in thermal communication with an interior of the pressure canner 48. Thus, the second thermocouple 40 is in thermal communication with the food item is cooked in the pressure canner 48. The second thermocouple 40 may be an electronic thermocouple that includes a male plug and a conductor extending between the male plug and the coupler 44. The male plug of the second thermocouple 40 may be inserted into the output port 24 on the hot plate 12.

A control unit 50 is coupled to the hot plate 12 and the control unit 50 can be set a desired temperature. The desired temperature may be a temperature ranging between approximately 80.0 degrees Fahrenheit and 400.0 degrees Fahrenheit. The control unit 50 is in electrical communication with the output port 24. The control circuit 20 receives the off input when the control unit 50 senses a temperature exceeding the desired temperature. The control circuit 20 receives the on input when the control unit 50 senses a temperature below the desired temperature. The control unit 50 may be positioned on the front side 18 of the hot plate 12.

The control unit 50 comprises a display 52 that is coupled to the hot plate 12 and the display 52 is coupled to the control circuit 20. The display 52 displays actual temperature indicia 54 comprises numbers indicating the temperature detected by the first or second thermocouple 40. Additionally, the display 52 displays desired temperature indicia 56 comprising numbers indicating the desired temperature selected with the control unit 50. The display 52 may be an LCD display or the like.

An increase button 58 is coupled to the hot plate 12 and the increase button 58 is electrically coupled to the control circuit 20. The increase button 58 increases the desired temperature toward a maximum temperature when the increase button 58 is manipulated. A decrease button 60 is coupled to the hot plate 12 and the decrease button 60 is electrically coupled to the control circuit 20. The decrease button 60 decreases the desired temperature toward a minimum temperature when the decrease button 60 is manipulated.

A power cord 68 is coupled to and extends away from the hot plate 12 and the power cord 68 is electrically coupled to the control circuit 20. The power cord 68 has a distal end 70 with respect to the hot plate 12 and a male plug 72 is electrically coupled to the distal end 70. The male plug 72 can be electrically coupled to a power source 74 comprising a female electrical outlet. A power button 76 is coupled to the hot plate 12, the power button 76 is electrically coupled to the control circuit 20 and the power button 76 turns the control circuit 20 on and off.

In use, the first thermocouple 26 is plugged into the output port 24 when the pot 28 is used for cooking. The first thermocouple 26 is draped downwardly into the pot 28 and the desired temperature is set on the hot plate 12. Thus, the cooking element 14 keeps the pot 28 at the desired temperature. The second thermocouple 40 is plugged into the output port 24 when the pressure canner 48 is being used to cook. The coupler 44 is coupled to the port 46 on the lid 47 of the pressure canner 48 and the desired temperature is set. In this way the temperature of the pressure canner 48 can be precisely controlled, thereby reducing the likelihood of an over-pressure condition with the pressure canner 48.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A heat sensing cooking assembly being configured to retain a cooking pot at a selected temperature, the assembly comprising:
a hot plate having a cooking element being positioned thereon, the cooking element producing heat when the cooking element is turned on;
a control circuit being coupled to the hot plate, the control circuit receiving an on input and an off input, said cooking element being turned on when said control circuit receives said on input, said cooking element being turned off when said control circuit receives said off input;
a thermometer being coupled to the hot plate, the thermometer being electrically coupled to the control circuit;
an output port being coupled to the hot plate, the output port being electrically coupled to the control circuit such that the output port is in electrical communication with the thermometer;
a first thermocouple being removably plugged into the output port such that the first thermocouple is in electrical communication with the thermometer, the first thermocouple being draped into a pot that has been placed on the cooking element thereby placing the first thermocouple in thermal communication with an interior of the pot wherein the first thermocouple is configured to be in thermal communication with a food item being cooked in the pot;
a second thermocouple being removably plugged into the output port such that the second thermocouple is in electrical communication with the thermometer, the second thermocouple having a distal end with respect to the output port, the distal end having a coupler thereon, the coupler releasably engaging a port on a lid of a pressure canner that has been placed on the cooking element such that the coupler is in thermal communication with an interior of the pressure canner wherein the second thermocouple is configured to be in thermal communication with the food item being cooked in the pressure canner; and
a control unit being coupled to the hot plate, the control unit setting a desired temperature, the control unit being in electrical communication with the output port, the control circuit receiving said off input when the control unit senses a temperature exceeding the desired temperature, said control circuit receiving said on input when the control unit sense a temperature below the desired temperature, the control unit being positioned on the front side of the hot plate.

2. The assembly according to claim 1, wherein the hot plate has a top side and a front side, the heating element being positioned on the top side.

3. The assembly according to claim 2, wherein the control unit comprises:
a display being coupled to the hot plate, the display being coupled to the control circuit, the display displaying actual temperature indicia comprising numbers indicating the temperature detected by the first or second thermocouple, the display displaying desired temperature indicia comprising numbers indicating the desired temperature;
an increase button being coupled to the hot plate, the increase button being electrically coupled to the control circuit, the increase button increasing the desired temperature toward a maximum temperature when the increase button is manipulated; and
a decrease button being coupled to the hot plate, the decrease button being electrically coupled to the control circuit, the decrease button decreasing the desired temperature toward a minimum temperature when the decrease button is manipulated.

4. The assembly according to claim 1, further comprising a power cord being coupled to and extending away from the hot plate, the power cord being electrically coupled to the control circuit, the power cord having a distal end with respect to the hot plate, the distal end having a male plug being electrically coupled thereto wherein the male plug is configured to be electrically coupled to a power source comprising a female electrical outlet.

5. A heat sensing cooking assembly being configured to retain a cooking pot at a selected temperature, the assembly comprising:
a hot plate having a cooking element being positioned thereon, the cooking element producing heat when the cooking element is turned on, the hot plate having a top side and a front side, the heating element being positioned on the top side;
a control circuit being coupled to the hot plate, the control circuit receiving an on input and an off input, said cooking element being turned on when said control circuit receives said on input, said cooking element being turned off when said control circuit receives said off input;
a thermometer being coupled to the hot plate, the thermometer being electrically coupled to the control circuit;
an output port being coupled to the hot plate, the output port being electrically coupled to the control circuit such that the output port is in electrical communication with the thermometer;
a first thermocouple being removably plugged into the output port such that the first thermocouple is in electrical communication with the thermometer, the first thermocouple being draped into a pot that has been placed on the cooking element thereby placing the first thermocouple in thermal communication with an interior of the pot wherein the first thermocouple is configured to be in thermal communication with a food item being cooked in the pot;
a second thermocouple being removably plugged into the output port such that the second thermocouple is in electrical communication with the thermometer, the second thermocouple having a distal end with respect to the output port, the distal end having a coupler thereon, the coupler releasably engaging a port on a lid of a pressure canner that has been placed on the cooking element such that the coupler is in thermal communication with an interior of the pressure canner wherein the second thermocouple is configured to be in thermal communication with the food item being cooked in the pressure canner;
a control unit being coupled to the hot plate, the control unit setting a desired temperature, the control unit being in electrical communication with the output port, the control circuit receiving said off input when the control unit senses a temperature exceeding the desired temperature, said control circuit receiving said on input when the control unit sense a temperature below the desired temperature, the control unit being positioned on the front side of the hot plate, the control unit comprising:
a display being coupled to the hot plate, the display being coupled to the control circuit, the display displaying actual temperature indicia comprising numbers indicating the temperature detected by the first or second thermocouple, the display displaying desired temperature indicia comprising numbers indicating the desired temperature;
an increase button being coupled to the hot plate, the increase button being electrically coupled to the control circuit, the increase button increasing the desired temperature toward a maximum temperature when the increase button is manipulated;
a decrease button being coupled to the hot plate, the decrease button being electrically coupled to the control circuit, the decrease button decreasing the desired temperature toward a minimum temperature when the decrease button is manipulated; and
a power cord being coupled to and extending away from the hot plate, the power cord being electrically coupled to the control circuit, the power cord having a distal end with respect to the hot plate, the distal end having a male plug being electrically coupled thereto wherein the male plug is configured to be electrically coupled to a power source comprising a female electrical outlet.
